(19) United States
(12) Patent Application Publication
(10) Pub. No.: US 2024/0308198 A1
(43) Pub. Date: Sep. 19, 2024

(54) COMPOSITE PANEL

(71) Applicants: Samuel J. Osten, Wexford, PA (US); Collin R. Gilarno, Freedom, PA (US); Michael A. Maravola, Canonsburg, PA (US)

(72) Inventors: Samuel J. Osten, Wexford, PA (US); Collin R. Gilarno, Freedom, PA (US); Michael A. Maravola, Canonsburg, PA (US)

(21) Appl. No.: 18/121,996

(22) Filed: Mar. 15, 2023

(51) Int. Cl. B32B 37/06; B32B 7/027; B32B 27/08; B32B 27/32

(52) U.S. Cl. CPC B32B 37/06; B32B 7/027; B32B 27/08; B32B 27/32; B32B 2250/04; B32B 2250/242; B32B 2260/021; B32B 2262/101; B32B 2307/518; B32B 2307/706; B32B 2307/732; B32B 2605/00; B32B 2607/00

(57) ABSTRACT

A composite panel is provided comprising first and third polymer plies having fibers therein that are substantially parallel to a first fiber axis and a second polymer ply having fibers therein that are substantially parallel to a second fiber axis. The first polymer ply comprises material with a first melting temperature, and the second and third polymer plies comprise material with a second melting temperature higher than the first melting temperature. Plies are bonded together to form a composite by heating the plies at a first heating temperature that is higher than the second melting temperature. First polymer ply material is provided at a first side of the composite. The first side of the composite is positioned adjacent to the core, and the composite and the core are heated at a second heating temperature that is higher than the first melting temperature but lower than the second melting temperature.

### FIELD

Embodiments relate generally to composite panels, the use of composite panels in structures, and methods of making composite panels, with the composite panels having support fibers therein and with various plies being heated to bond the plies together to form the composite panel

### BACKGROUND

It is known to use wall panels having a thin outer sheet of fiberglass when constructing walls of various vehicles such as recreational vehicles, trailers, mobile homes, etc., because the thin fiberglass sheet presents an aesthetically pleasing surface. For example, one such wall panel consists of the fiberglass sheet adhered to a plywood substrate, such as by gluing. However, plywood substrates are susceptible to water damage, surface inconsistencies such as knots, irregular grain, etc., and joints between the plywood substrates of adjacent panels can be difficult to construct smoothly. As well, other known wall panels may have outer surfaces formed by other materials such as, but not limited to, polymer films, aluminum, etc.

Another known wall panel includes a fiberglass film adhered to a fiberglass/polypropylene substrate layer. These wall panels work well for planar wall sections, but tend to be fairly rigid. Difficulties can arise when using such wall sections in the front portions of trailers, recreational vehicles, etc., where it is often desirable to curve the wall, for example, where the top of a wall section joins an opposing roof panel. Attempts have been made to add more flexible top sections to such wall panels, which lead to additional manufacturing complexity, joints in the panels and subsequent cost increases. For example, top wall panel sections formed from plywood with multiple, shallow elongated grooves therein have been utilized to allow greater flexibility, as well as top sections including multiple elongated plywood strips adhered to a flexible base layer.

Additionally, wall panels are frequently formed using adhesive layers. These adhesive layers are often difficult to apply, and difficulty may arise in applying the adhesive uniformly between the layers. The adhesive layer is typically spread out in a plane to assist in securing two adjacent layers together. However, the adhesive layer often provides limited structural support in directions extending along the plane of the adhesive layer.

The present invention may recognize and address one or more considerations of prior art constructions and methods, as recited above or otherwise.

### BRIEF SUMMARY

One embodiment of the present disclosure provides a composite panel of a vehicle having a floor structure that is supported by at least one pair of wheels, a roof structure spaced from and disposed opposite the floor structure, a pair of opposed sidewalls spaced from each other and extending between the floor structure and the roof structure, and a front wall and a rear wall opposing each other and extending between the floor structure and the roof structure. The composite panel comprises a first polymer ply having a plurality of fibers embedded therein that are substantially parallel to a first fiber axis of the composite panel. The first polymer ply comprises material with a first melting temperature. The composite panel also comprises a second polymer ply having a plurality of fibers embedded therein that are substantially parallel to a second fiber axis of the composite panel, and the second polymer ply is bonded to the first polymer ply so that the second fiber axis is substantially perpendicular to the first fiber axis. The second polymer ply comprises material with a second melting temperature that is higher than the first melting temperature. The composite panel also comprises a third polymer ply having a plurality of fibers embedded therein, and the third polymer ply is bonded to the second polymer ply opposite the first polymer ply so that the plurality of fibers of the third polymer ply is substantially parallel to the first fiber axis. The third polymer ply comprises material with the second melting temperature. The composite panel also comprises a core. The first polymer ply, the second polymer ply, and the third polymer ply are bonded together to form a composite by lamination at a first lamination temperature that is higher than the second melting temperature. The initial material from the first polymer ply is provided at a first side of the composite. The composite is bonded to the core by positioning the first side of the composite adjacent to the core and laminating the composite and the core at a second lamination temperature that is higher than the first melting temperature but lower than the second melting temperature.

In an embodiment of the present disclosure, a method of forming a composite panel for a vehicle is provided. The method comprises providing a first polymer ply having a plurality of fibers embedded therein. The plurality of fibers are substantially parallel to a first fiber axis of the composite panel, and the first polymer ply comprises material with a first melting temperature. The method also comprises providing a second polymer ply having a plurality of fibers embedded therein. The plurality of fibers of the second polymer ply are substantially parallel to a second fiber axis of the composite panel, and the second polymer ply comprises material with a second melting temperature that is higher than the first melting temperature. The method also comprises providing a third polymer ply having a plurality of fibers embedded therein. The third polymer ply comprises material with the second melting temperature. The method also comprises positioning the second polymer ply between the first polymer ply and the third polymer ply so that the second polymer ply abuts the first polymer ply and the third polymer ply. The second polymer ply is positioned relative to the first polymer ply so that the second fiber axis is substantially perpendicular to the first fiber axis, and the third polymer ply is positioned relative to the second polymer ply opposite the first polymer ply so that the plurality of fibers of the third polymer ply is substantially parallel to the first fiber axis. The method also comprises heating the first polymer ply, the second polymer ply, and the third polymer ply at a first temperature to cause the first polymer ply, the second polymer ply, and the third polymer ply to bond together to form a composite with material from the first polymer ply at a first side of the composite, and the first temperature is higher than the second melting temperature. The method also comprises providing a core and positioning the core adjacent to the first side of the composite so that the core and the first side of the composite abut each other. The method also comprises heating the composite and the core to a second temperature that is greater than the first melting temperature but less than the second melting temperature.

In some embodiments, the first polymer ply, the second polymer ply, and the third polymer ply each comprise a polymer sheet. Additionally, in some embodiments, the first polymer ply, the second polymer ply, and the third polymer ply each comprise a polypropylene material. Furthermore, in some embodiments, the material of the first polymer ply has a melting temperature between approximately 149 degrees Celsius and approximately 157 degrees Celsius, and the material of the second polymer ply and the third polymer ply has a melting temperature between approximately 158 degrees Celsius and approximately 166 degrees Celsius. In some embodiments, the core comprises a polypropylene material having approximately the same melting temperature as the material of the first polymer ply.

In some embodiments, the first polymer ply, the second polymer ply, and the third polymer ply each comprise a polymer resin material. Additionally, in some embodiments, the composite panel is disposed so that the first fiber axis is substantially parallel to the floor structure. In some embodiments, rigidity of the composite panel is greater along the first fiber axis than the second fiber axis.

In some embodiments, the composite panel does not comprise any adhesive layer. In some embodiments, the fibers of the first, the second, and the third polymer layers are glass fibers. In some embodiments, a glass to resin ratio of the fibers within the composite that are parallel to the first fiber axis is greater than a glass to resin ratio of the fibers within the composite that are parallel to the second fiber axis. Additionally, in some embodiments, respective thicknesses of the first polymer layer, the second polymer layer, and the third polymer layer in a direction perpendicular to the first fiber axis and the second fiber axis are substantially the same.

In another embodiment of the present disclosure, a composite panel is provided. The composite panel comprises a first polymer ply having a plurality of fibers embedded therein. The plurality of fibers is substantially parallel to a first fiber axis of the composite panel, and the first polymer ply comprising material with a first melting temperature. The composite panel also comprises a second polymer ply having a plurality of fibers embedded therein. The plurality of fibers of the second polymer ply is substantially parallel to a second fiber axis of the composite panel, and the second polymer ply abuts the first polymer ply. The second polymer ply is bonded to the first polymer ply so that the second fiber axis is substantially perpendicular to the first fiber axis, and the second polymer ply comprises material with a second melting temperature that is higher than the first melting temperature. The composite panel also comprises a third polymer ply having a plurality of fibers embedded therein. The third polymer ply abuts the second polymer ply, and the third polymer ply is bonded to the second polymer ply opposite the first polymer ply so that the plurality of fibers of the third polymer ply is substantially parallel to the first fiber axis. The third polymer ply comprises material with the second melting temperature. The composite panel also comprises a core. The first polymer ply, the second polymer ply, and the third polymer ply are bonded together to form a composite by heating the first polymer ply, the second polymer ply, and the third polymer ply at a first temperature that is higher than the second melting temperature. The initial material from the first polymer ply is provided at a first side of the composite, and the composite is bonded to the core by positioning the first side of the composite adjacent to the core and heating the composite and the core at a second temperature that is higher than the first melting temperature but lower than the second melting temperature.

In some embodiments, the first polymer ply, the second polymer ply, and the third polymer ply each comprise a polymer sheet including a polypropylene material. Additionally, in some embodiments, the material of the first polymer ply has a melting temperature between approximately 149 degrees Celsius and approximately 157 degrees Celsius, and the material of the second polymer ply and the third polymer ply has a melting temperature between approximately 158 degrees Celsius and approximately 166 degrees Celsius. In some embodiments, the core comprises a polypropylene material having approximately the same melting temperature as the material of the first polymer ply. In some embodiments, the composite panel does not comprise any adhesive layer.

In some embodiments, the composite panel also comprises a first scrim layer bonded to an outer surface of the first polymer layer and a second scrim layer bonded to an outer surface of the third polymer layer. Additionally, in some embodiments, the composite panel also comprises a fiberglass sheet bonded to one of the first and the second scrim layers.

In another embodiment of the present disclosure, a vehicle is provided. The vehicle comprises a chassis including a wheel assembly and a body supported by the chassis. The body includes a floor structure, a roof panel, a pair of sidewalls, a rear wall and a front wall. The front wall includes a curved portion, and the curved portion is formed by at least one composite wall panel. The at least one composite wall panel comprises a first polymer ply having a plurality of fibers embedded therein. The plurality of fibers are substantially parallel to a first fiber axis of the composite wall panel, and the first polymer ply comprises material with a first melting temperature. The at least one composite wall panel also comprises a second polymer ply having a plurality of fibers embedded therein. The plurality of fibers of the second polymer ply are substantially parallel to a second fiber axis of the composite wall panel, and the second polymer ply is bonded to the first polymer ply so that the second fiber axis is substantially perpendicular to the first fiber axis. The second polymer ply comprising material with a second melting temperature that is higher than the first melting temperature. The at least one composite wall panel also comprises a third polymer ply having a plurality of fibers embedded therein. The third polymer ply is bonded to the second polymer ply opposite the first polymer ply so that the plurality of fibers of the third polymer ply is substantially parallel to the first fiber axis, and the third polymer ply comprises material with the second melting temperature. The at least one composite wall panel also comprises a core. The first polymer ply, the second polymer ply, and the third polymer ply are bonded together to form a composite by heating the first polymer ply, the second polymer ply, and the third polymer ply at a first heating temperature that is higher than the second melting temperature. Initial material from the first polymer ply is provided at a first side of the composite. The composite is bonded to the core by positioning the first side of the composite adjacent to the core and heating the composite and the core at a second heating temperature that is higher than the first melting temperature but lower than the second melting temperature.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a vehicle including a composite panel in accordance with the present disclosure;

FIG. 2 is a partial cross-sectional view of the composite panel of the vehicle as shown in FIG. 1;

FIG. 3 is a schematic illustration of an apparatus for forming a composite panel in accordance with the present disclosure;

FIG. 4 is a schematic illustration of multiple plies of material where support fibers are embedded in the plies and where the plies are rotated 90 degrees From layer to layer in accordance with the present disclosure;

FIG. 5A is a schematic illustration of an initial lamination system where the temperature is heated above the melting temperature of all plies of material in accordance with the present disclosure;

FIG. 5B is a schematic illustration of two composites that are formed from the initial lamination process shown in FIG. 5A;

FIG. 5C is a schematic illustration of a further lamination system illustrating the two example composites of FIG. 5B being adhered to a core in accordance with the present disclosure; and

FIG. 6 is a flow chart illustrating an example method of forming a composite panel in accordance with the present disclosure.

Repeat use of reference characters in the present specification and drawings is intended to represent same or analogous features or elements of the invention according to the disclosure.

### DETAILED DESCRIPTION

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present disclosure covers such modifications and variations as come within the scope of the appended claims and their equivalents. All values indicated below are intended to be approximated values.

It should be understood that terms of orientation, e.g., “forward,” “rearward,” “upper,” “lower,” and similar terms as used herein are intended to refer to relative orientation of components of the devices described herein with respect to each other under an assumption of a consistent point of reference but do not require any specific orientation of the overall system. Thus, for example, the discussion herein may refer to the “forward,” “rearward,” “lateral,” “side,” or similar descriptions, referring to areas of or directions with respect to a vehicle. Such terms may be used in the present disclosure and claims and will be understood to refer to a relative orientation but not to an orientation of a claimed device with respect to an external frame of reference.

Further, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. The phrase “at least one of A and B” is satisfied by any of A alone, B alone, A and B alone, and A and B with others. The phrase “one of A and B” is satisfied by A, whether or not also in the presence of B, and by B, whether or not also in the presence of A.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

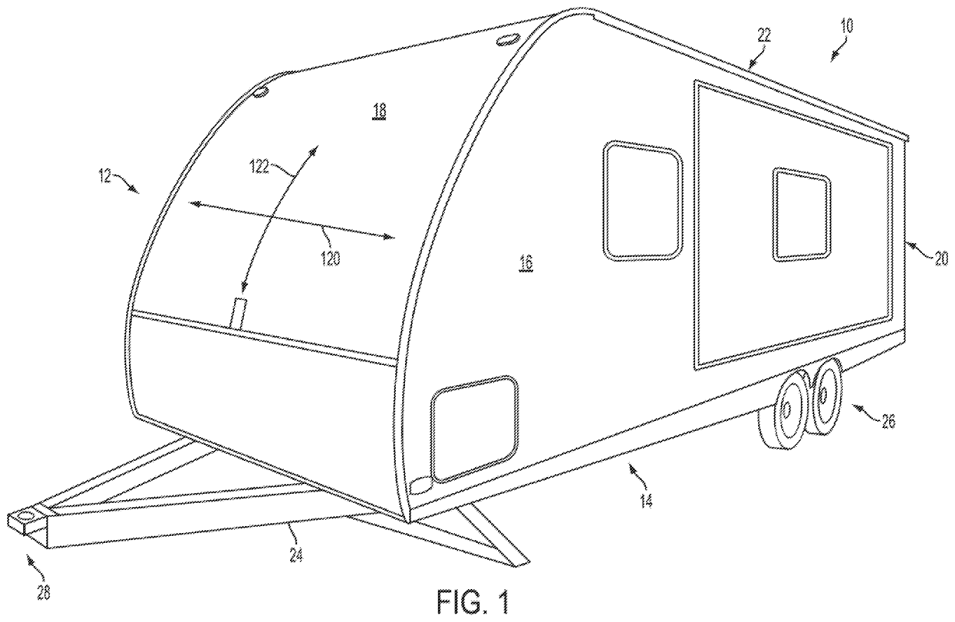

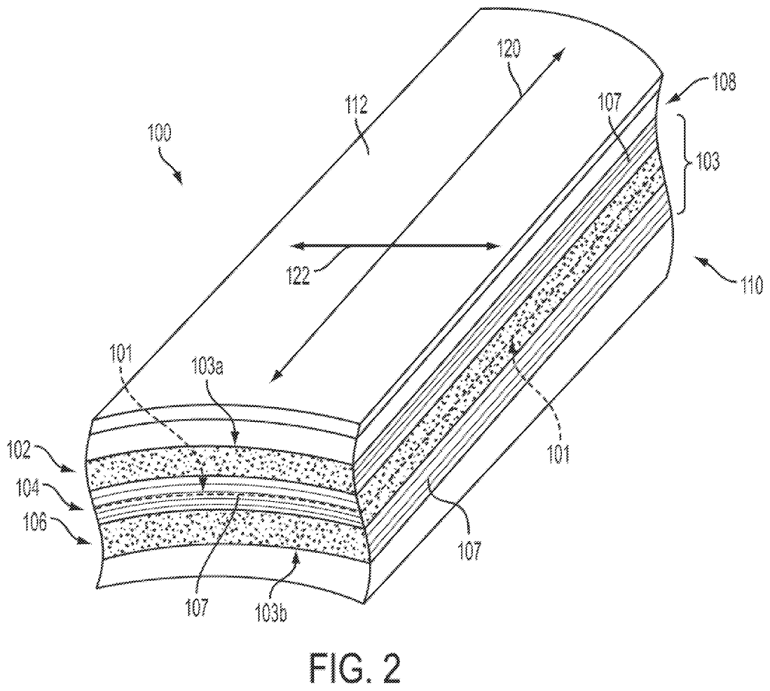

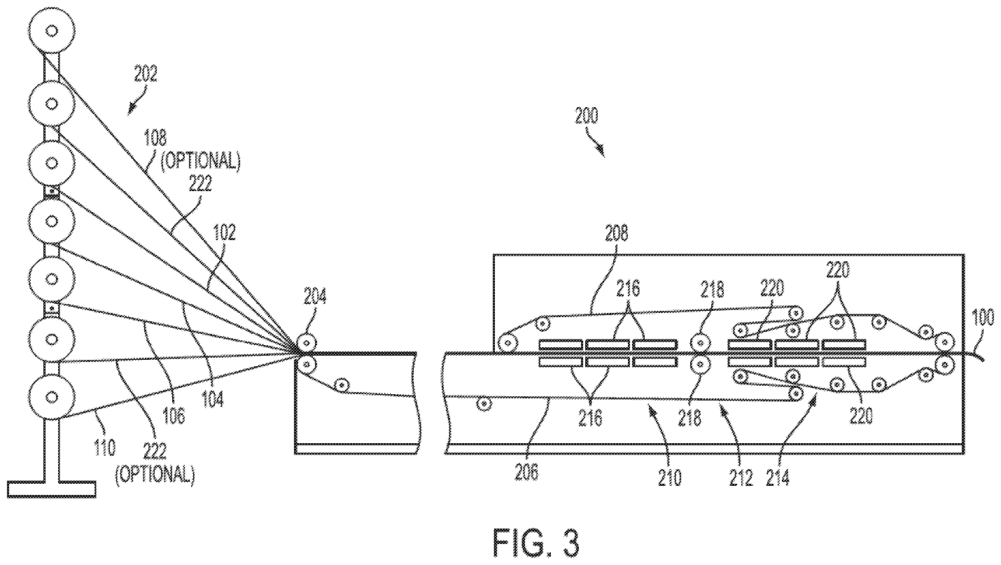

Referring now to the Figures, FIG. 1 shows a recreational vehicle, specifically a trailer 10, in which composite panels (FIGS. 2 and 3) constructed in accordance with an embodiment of the present disclosure are used. As shown, trailer 10 includes a body 12 that is supported by a chassis 24. Body 12 includes a floor structure 14 that is secured to chassis 24, a roof panel 22, a pair of parallel, opposing side walls 16 (only one of which is shown in FIG. 1), a front wall 18 and a rear wall 20, all extending between floor structure 14 and roof panel 22. As in the example shown, it is known for the vehicle front wall to include at least a curved portion to both improve the vehicle's aerodynamics and provide an aesthetically pleasing appearance. In the instant case, front wall 18 of trailer 10 forms a continuous curve (when considered in a plane perpendicular to the generally planar floor and including a longitudinal center axis of the floor perpendicular to the wheel axis) between floor structure 14 and roof panel 22. To allow towing by another vehicle, chassis 24 includes a hitch receiver 28 and wheel assembly 26. While one potential use of composite panels is to serve as a composite wall panel in recreational vehicles and trailers, composite panels may also be utilized in a wide variety of other ways. For example, composite panels may be used for shelving, stage flooring, other flooring, scaffolding, etc.

FIG. 2 provides a cross-sectional view of a composite panel 100 in accordance with one embodiment of the present disclosure. Composite panel 100 includes multiple fiber reinforced polymer layers. Each of a first polymer resin layer 102, a second polymer resin layer 104, and a third polymer resin layer 106 includes a plurality of elongated fibers embedded in a co-polymer material. For the embodiment shown, the fibers are continuous strand glass fibers that are embedded in a polypropylene co-polymer so that the continuous strand glass fibers within each layer are generally parallel to each other when considered in the dimension of the glass strands' dimensions of elongation. The first, second and third polymer resin layers 102, 104 and 106 are positioned over one another and are consolidated to form a unitary polymer resin layer 103 of composite panel 100. Second polymer resin layer 104 is disposed between first polymer resin layer 102 and third polymer resin layer 106 such that fibers 107 of second polymer resin layer 104 are aligned in a direction (in the fibers' dimension of elongation) that is perpendicular to a direction (dimension of elongation) in which fibers 107 of first polymer resin layer 102 and third polymer resin layer 106 are aligned. Specifically, fibers 107 of first polymer resin layer 102 and third polymer resin layer 106 are aligned substantially parallel to a first fiber axis 120 (FIG. 1) of composite panel 100, whereas fibers 107 of second polymer resin layer 104 are aligned substantially parallel to a second fiber axis 122 of composite panel 100.

In the embodiment shown in FIG. 2, the first, second and third polymer resin layers are similar, meaning both the thickness of the layers and the density of fibers within each layer are substantially the same. In the present embodiment, the first, second and third polymer layers are preferably between about 0.008″ to about 0.016″ thick and have a weight of about 0.06 to about 0.15 lbs/sq. ft. As such, the glass to resin ratio of fibers 107 within unitary polymer resin layer 103 of composite panel 100 that are substantially parallel to first fiber axis 120 is greater than the glass to resin ratio of fibers 107 within unitary polymer resin layer 103 that are substantially parallel to second fiber axis 122. That is, a greater number of fibers within unitary layer 103 (i.e. the combined layers 102/104/106) are aligned parallel to the first fiber axis direction (120) as compared to the number of fibers aligned parallel to the second fiber axis direction (122), and there is a greater cross sectional (in a plane including axis 122 and perpendicular to axis 120) area of fibers in direction 120 than the cross sectional (in a plane including axis 120 and perpendicular to axis 122) area of fibers in direction 122. Composite panel 100 therefore exhibits greater rigidity, and correspondingly resistance to bending, along first fiber axis 120 than along second fiber axis 122.

Composite panel 100 exhibits greater rigidity along first fiber axis 120 based not only on the higher cross-sectional area of fibers aligned with first fiber axis 120, but also due to the position of those fibers relative to a center plane 101 of unitary polymer resin layer 103 of the composite panel. Specifically, center plane 101 is disposed in the middle of unitary polymer resin layer 103, substantially parallel to the outermost major surfaces 103a and 103b of the layer. As such, center plane 101 is disposed within second polymer resin layer 104. Therefore, as shown in FIG. 2, fibers 107 of first and third polymer resin layers 102 and 106 are spaced at greater distances (considered in a direction perpendicular to center plane 101) from center plane 101 than are fibers 107 of second polymer resin layer 104. When attempting to bend composite panel 100 along first fiber axis 120, fibers 107 of first and second polymer resin layers 102 and 106 are under greater compression and tension (depending on the bending direction) than are those of second polymer resin layer 104 when attempting to bend composite panel 100 relative to second fiber axis 122. In short, because fibers 107 of second polymer resin layer 104 are closer to center plane 101, they are placed under less compression and/or tension during bending. Even if the thickness of second polymer resin layer 104 is equal to that of combined first and third polymer resin layers 102 and 106 (which is an embodiment under the present disclosure, as are thicknesses of layer 104 between half of and equal to the combined thickness of layers 102 and 106), the composite panel exhibits greater rigidity along first fiber axis 120 due to the increased distance of fibers 107, of the first and third polymer resin layers, from center plane 101.

In other embodiments, the glass-to-resin ratios of fibers 107 in layers 102/106 and of fibers 107 in layer 104 (each considered within layer 103 as a whole) may vary, as may the relative thicknesses of those two layers (102/106 and 104). In certain embodiments, for example, fibers 107 within center layer 104 of unitary polymer resin layer 103 of composite panel 100 are within (whether considered by weight, number of fibers of constant construction, or by layer thicknesses when fiber density remains constant) a range of about 20% to about 40% of the total fibers in unitary layer 103, whereas fibers 107 within outer layers 102 and 106 of layer 103 are within a range of about 60% to about 80% of the total fibers in layer 103. That is, in these embodiments, about 20% to about 40% of the fibers in layer 103 are aligned in dimension 122, while about 60% to about 80% of the fibers in layer 103 are aligned in dimension 120. In these or other embodiments, the overall thickness of composite panel 100 is within a range of about 0.020″ to about 0.070″, with a weight percent glass of about 30% to about 75%.

As further shown in FIG. 2, composite panel 100 also includes a first scrim layer 108 and a second scrim layer 110 that are laminated to the outermost surfaces of first polymer resin layer 102 and third polymer resin layer 106, respectively. First and second scrim layers 108 and 110 provide a relatively rough surface to which additional layers may be readily adhered. For example, in the present embodiment, a thermoset fiberglass sheet 112 is adhered to first scrim layer 108 with adhesive bonding to provide an aesthetically pleasing outer surface of composite panel 100. In one or more embodiments, fiberglass sheet 112 has a thickness of about 0.010″ to about 0.060″. In one or more other embodiments, each of the inner and outer layers of composite panel 100 (i.e., replacing scrim layer 108 as the innermost layer and scrim layer 110/sheet 112 as the outermost layer) may be formed by respective sheets of fiberglass reinforced thermoplastic resin or fiberglass reinforced thermoset resin and including a gel coat.

In use, referring again to FIG. 1, composite panel 100 may be used to form any one, or all, of side walls 16, front wall 18, rear wall 20 and roof panel 22. Advantages offered by one or more embodiments of composite panel 100, e.g., increased rigidity along first fiber axis 120 with respect to second fiber axis 122, may be notable when composite panel 100 is used to form a wall including a curved portion, such as front wall 18. As shown, by aligning composite panel 100 such that its first fiber axis 120 is substantially parallel to the horizontal floor structure 14 of trailer 10, rigidity of front wall 18 can be maintained along first fiber axis 120, while still allowing for flexibility along second fiber axis 122 so that front wall 18 may be given a desired amount of curve. Further, composite panel 100 may be used to form roof panel 22, wherein composite panel 100 is aligned such that its first fiber axis 120 is substantially parallel to the longitudinal center axis of the trailer's floor. In this manner, the rigidity of roof panel 22 is maintained from front to back of the panel, while still allowing for the side edges of the roof panel to be bent downwardly to meet the portions of sidewalls 16. As such, roof panel 22 can be unitarily formed.

FIG. 3 schematically illustrates a machine 200 that consolidates the multiple layers of material into the composite panel shown in FIG. 2. Machine 200 applies heat and pressure to the multiple layers to consolidate the raw materials into a substantially rigid sheet and to achieve a desired density in the laminate. One suitable consolidation machine 200 is a contact heat oven manufactured and sold by Schott & Meissner GmbH of Germany under the name THERMOFIX. FIG. 3 should be understood to be a representative schematic example provided for illustrative purposes, however, and other consolidation machines may be used to form the laminate of the present invention.

A rack 202 of machine 200 holds multiple rolls of material that are fed into a pair of belt rollers 204 driven by a lower belt 206 so that the layers are carried downstream into the machine on the lower belt. Each generally planar layer is coplanar with the adjacent upper and/or lower layers and is generally of the same length and width so that the resultant material has uniform properties throughout.

The raw materials that form the composite panel are, in one or more embodiments, stored on large rolls in rack 202. FIG. 3 illustrates seven materials being fed in a coplanar manner into consolidator 200: a first scrim layer 108, a first optional adhesive layer 222, a first polymer resin layer 102, a second polymer resin layer 104, a third polymer resin layer 106, a second optional adhesive layer 222 and a second scrim layer 110. Each layer is approximately the same width and length as the other layers so that the resultant composite laminate panel 100 is uniform from end to end. In the previously described embodiment of composite panel 100 (FIG. 2), adhesive layers 222 are not used because first and second scrim layers 108 and 110 are embedded in the outer surfaces of first polymer resin layer 102 and third polymer resin layer 106, respectively, during the lamination process. However, in alternate embodiments, adhesive layers 222 may be used. Suitable adhesive layers include a UAF polyurethane adhesive film and a PAF polyester based heat activated adhesive film, each manufactured by Adhesive Films, Inc. of Pine Brook, N.J. It should also be understood that other forms of adhesives can be used. For example, spray adhesive can be applied to the outer surfaces of first and third polymer resin layers 102 and 106 prior to being fed into belt rollers 204. In another example, the first and third polymer resin layers can be roll coated with adhesive prior to being fed into belt rollers 204.

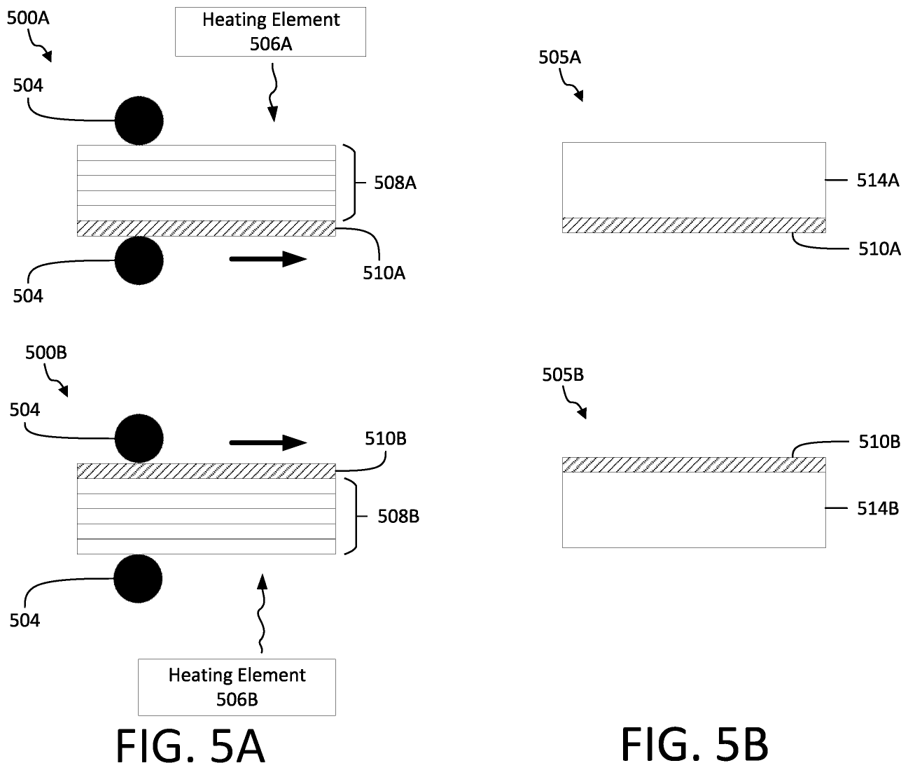

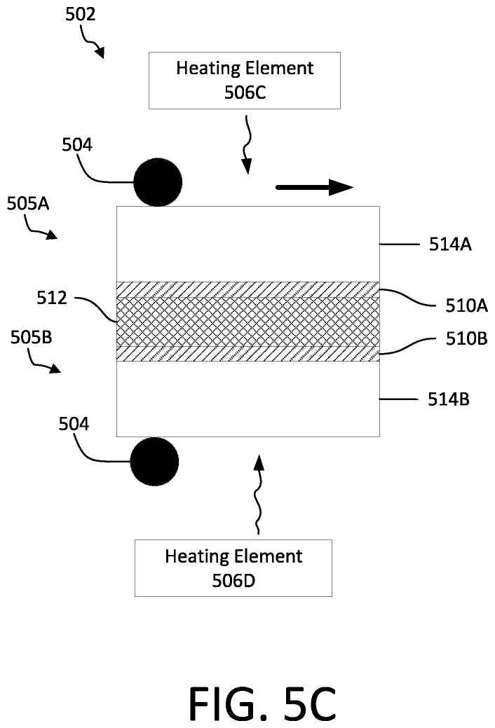

In other embodiments, e.g., as discussed hereinbelow, each of layers, or plies, 102, 104, and 106 is a fiber reinforced thermoplastic (e.g., polypropylene) layer with the direction of glass fibers (which are parallel within the sheet) alternating 90° from layer to layer, as discussed above. Plies 102, 104, 106 comprise a polymer material. Plies 102, 104, 106 may comprises semicrystalline polymer thermoplastic in some embodiments. In some embodiments, plies 102, 104, 106 may comprise a polypropylene. In some embodiments, plies 102, 104, 106 may comprise a copolymer polypropylene. In some embodiments, plies 102, 104, 106 may comprise an isotactic copolymer polypropylene. In further embodiments as described herein, no adhesive layer (222) is used or present. Scrim layers 108 and 110 are omitted and may, in one or more embodiments, be replaced with additional fiber reinforced semicrystalline thermoplastic (e.g., a copolymer polypropylene) layers, the glass fibers of which are elongated with the fibers' dimensions of elongation being parallel to each other within each layer and are oriented 90° with respect to the glass fiber orientation of the layers adjacent to them, as discussed above. Thus, there are five glass-reinforced polypropylene layers in such embodiments. In one or more other embodiments, the consolidated panel is manufactured entirely by such polypropylene layers, using the individual polymer layers with glass fibers parallel to each other. In either arrangement, the resulting composite sheet is made wholly of the glass-reinforced polymer and may be manufactured utilizing a consolidation machine such as machine 200, as should be understood with regard to FIGS. 5A-5C.

Referring again to FIG. 3, belt 206 faces opposite a belt 208 so that the layers of material are sandwiched between the belts. Belts 206 and 208 are coated with a non-adherent releasing film surface, for example stainless steel, TEFLON or other suitable material, so that the laminate material easily releases from the belt at the end of the machine. Belts 206 and 208 pass the layers through a heating stage 210, a calendar stage 212 and a cooling stage 214. Heating stage 210 includes pan type heating elements 216 that carry heated oil to conduct heat through belts 206 and 208 and into the input materials. The heating of first, second and third polymer resin layers 102, 104 and 106, respectively, above their respective melt temperature causes the thermoplastic materials to flow so that added pressure by belt rollers 218 in calendar section 212 causes the adjacent polymer layers to intermingle and bond.

Belt rollers 218 of calendar stage 212 apply sufficient pressure to the materials so that they bond to form a generally uniform composite panel 100. The amount of pressure depends on the temperature of the input materials and the desired thickness of composite panel 100. Once the materials have been consolidated, the soft pliable composite panel 100 solidifies at cooling stage 214. The cooling stage employs cooling pans 220 that carry water to dissipate heat retained in the laminate. The temperature of the cooling water varies between 10 and 20 degrees Centigrade depending on the number of layers in the laminate and the speed of the machine so that in a preferred embodiment, the laminate is cooled to a temperature at which the laminate panel is stable and will not warp. Consolidating machine 200 is able to form a continuous sheet of varying width and length of composite material that can then be rolled, or cut and stacked in sheets, for storage.

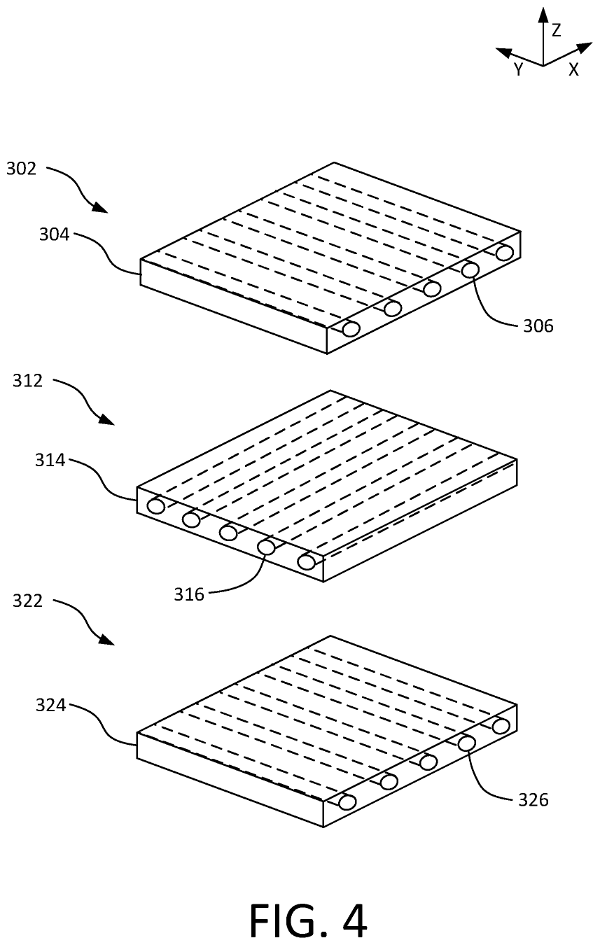

Multiple plies of material may be provided with elongated support fibers, as discussed above, provided therein. FIG. 4 is a schematic illustration of multiple plies of material where support fibers are embedded in the plies and where the plies are rotated 90 degrees from layer to layer. These support fibers may provide increased rigidity in a final composite panel that is formed, as discussed above.

In FIG. 4, a first polymer ply 302, a second polymer ply 312, and a third polymer ply 322 are illustrated. First polymer ply 302 comprises a base material 304 and elongated support fibers 306, with support fibers 306 in the ply generally extending parallel to each other. Second polymer ply 312 comprises a base material 314 and support fibers 316, with support fibers 316 in the ply generally extending (in their dimension of elongation) parallel to each other. Third polymer ply 322 comprises base material 324 and support fibers 326, with support fibers 326 in the ply generally extending parallel to each other. Base material 304, base material 314, and base material 324 may each be polymer material. This polymer material may comprise a semicrystalline polymer thermoplastic in some embodiments. In some embodiments, base materials 304, 314, 324 may comprise a polypropylene and may be provided in the form of a sheet. In some embodiments, base materials 304, 314, 324 may comprise a copolymer polypropylene. In some embodiments, base materials 304, 314, 324 may comprise an isotactic copolymer polypropylene.

As illustrated in FIG. 4, support fibers 316 of second polymer ply 312 extend at an angle that is parallel to the X-axis, and support fibers 306 and support fibers 326 extend at an angle that is parallel to the Y-axis, as those directions are represented in FIG. 4. Thus, the dimension of elongation of support fibers 316 is generally perpendicular to the dimension of elongation of support fibers 306 and support fibers 326. Additional plies may be added above first polymer ply 302 and/or below third polymer ply 322 so that the support fibers in adjacent plies alternate between extending (in their dimensions of elongation) generally along the Y-axis and generally along the X-axis. In this way, the plies may be bonded together so that the support fibers provide increased strength along both the X-axis and the Y-axis.

In other embodiments, the support fibers of adjacent plies are oriented in other ways. For example, the support fibers of a first layer may extend (in their elongation dimensions) parallel to the Y-axis, the support fibers of a second layer may extend along the X-Y plane in a direction that is spaced 45 degrees from the X-axis and spaced 45 degrees from the Y-axis, and the support fibers of a third layer may extend parallel to the Y-axis.

In some embodiments, the total number of elongated fibers in the plies extending in a dimension parallel to a first fiber axis (e.g., the X-axis in FIG. 4) may be greater than the number of elongated fibers in the plies extending in a dimension parallel to the second fiber axis (e.g., the Y-axis in FIG. 4) so that the rigidity of the composite panel may be greater along the first fiber axis or dimension than it is along the second fiber axis or dimension. However, in other embodiments, the total number of elongated fibers in the plies extending in a dimension parallel to the first fiber axis may be equal to the number of fibers in the plies extending in a dimension parallel to the second fiber axis so that the rigidity of the composite panel along the first fiber axis may be the same as the rigidity of the composite panel along the second fiber axis.

In the illustrated embodiment, the base material 304, the base material 314, and the base material 324 may each be a fiberglass reinforced polymer sheet. For example, these base materials may comprise polypropylene. In some embodiments, the base materials 304, 314, 324 each comprise identical materials. However, in other embodiments, the material may be different.

In some embodiments, various plies may be bonded together through a lamination process without the use of any separate adhesive layer, as discussed above with respect to consolidation machine 200 (FIG. 3). The base materials in the plies may be heated above a melting temperature of all of the base materials so that the plies may be bonded together to form a composite, and then the plies may be heated a second time to a temperature that is greater than the melting temperature of only a portion of the plies to thereby bond the formed composite to a core or to another panel formed as a similar composite of glass fiber-reinforced polymer plies.

FIG. 5A is a schematic illustration of an initial lamination process in which the temperature during lamination is maintained above the melting temperature of the polymer base materials in all of the plies in the machine, in accordance with the present disclosure. FIG. 5B is a schematic illustration of two composites that are respectively formed from the initial lamination process shown in FIG. 5A.

In FIG. 5A, a first lamination system 500A and a second lamination system 500B, each of which being representative of a consolidation machine as discussed above (and which may be the same machine, operated at different runs), are illustrated. While illustrated in part, the lamination system may be as described above with respect to machine 200 and FIG. 3. Each of the lamination systems comprise belt rollers 504 (of consolidation machine 200; FIG. 3), and the systems are each configured to receive a plurality of plies between belt rollers 504. The plies may include elongated support fibers 316 (see FIG. 4) therein, and elongated support fibers 316 in adjacent plies may be oriented differently to provide increased strength in multiple directions for the final product that is formed. For example, elongated support fibers 316 in adjacent plies may be generally perpendicular to each other as illustrated in FIG. 4.

The plies are pulled in the direction of the arrows during lamination. First lamination system 500A comprises a heating element 506A, and second lamination system 500B comprises a heating element 506B. Heating elements 506A and 506B are illustrated as being positioned on one side of the plies that are received between the belt rollers 504, but it should be understood that this is a schematic illustration and that the heating elements may take various forms and be disposed in various locations, such as within the belt rollers or as belt heating elements (see FIG. 3, at 216). Thus, it should be understood that additional heating elements may be provided, and various types of heating elements may be used in the lamination systems 500A, 500B.

Various plies of material are received in the lamination systems. In first lamination system 500A, a boundary ply 510A is provided on one side of the plurality of plies otherwise consisting of plies 508A. Plies 508A are generally identical to each other in the illustrated embodiment and may be referred to herein as common plies. Boundary ply 510A may comprise a base material polymer that is similar to the base material polymer used for plies 508A, but the base material polymer of boundary ply 510A has a melting temperature that is lower than the melting temperature of the base material polymers of plies 508A. The base material of boundary ply 510A may comprise a semicrystalline polymer thermoplastic in some embodiments. Semicrystalline polymer thermoplastics may be beneficial as these thermoplastics melt over a narrow melt temperature range, allowing these materials to be melted as intended when the semicrystalline polymer thermoplastics are heated above their respective melting temperature. By contrast, amorphous thermoplastics do not melt precisely, and may even be said not to have a melt temperature, instead changing phase more slowly over a broader temperature range, which may be referred to as the material's glass transition temperature.

Thermoplastic base materials for boundary plies 510A, 510B and for plies 508A, 508B may comprise polypropylene in some embodiments. In some embodiments, the base materials may comprise a copolymer polypropylene. In some embodiments, the base materials may comprise an isotactic copolymer polypropylene. In the illustrated embodiments, the base material of boundary ply 510A is a type of polypropylene having a melting temperature lower than the melting temperature of a polypropylene type forming the base materials of plies 508A. Heating element 506A is configured to generate heat so that the temperature of the base materials within the fiber reinforced polymer plies 510A and 508A within the laminate process is raised to a level that is higher than the melting temperature of those base materials. By melting the base materials of all the plies and applying pressure at the belt rollers, the consolidation machine causes the base materials of boundary ply 510A and common plies 508A to mix and thereby bond together to form a composite 505A as illustrated in FIG. 5B. In this composite 505A, the base material of boundary ply 510A will, because ply 510A is one of the two outermost plies fed into the consolidation machine (FIG. 3, 200), generally remain positioned in close proximity to one side of composite 505A. The various plies 508A are bonded together to form a combined layer 514A. Boundary plies 510A, 510B and plies 508A, 508B may each comprise elongated support fibers 306 (see FIG. 4).

In second lamination system 500B, a boundary ply 510B is provided on one side of the plurality of plies otherwise consisting of common plies 508B. Plies 508B are generally identical to each other in the illustrated embodiment. Boundary ply 510B may comprise a base material that is the same as or similar to the base material used for plies 508B, but the base material polymer of boundary ply 510B has a melting temperature that is lower than the melting temperature of the base materials of common plies 508B. In the illustrated embodiments, the base material of boundary ply 510B is a type of polypropylene having a melting temperature lower than the melting temperature of a polypropylene type forming the base materials of common plies 508A. Heating element 506B is configured to generate heat so that the temperature within the laminate process is raised to a first heating temperature that is higher than the melting temperature of the base materials of boundary ply 510B and of plies 508B. By melting the base materials of all the plies and applying pressure at the belt rollers, the consolidation machine causes the base materials of boundary ply 510B and of common plies 508B to mix and thereby bond together to form a composite 505B as illustrated in FIG. 5B. In this composite 505B, the base material of boundary ply 510B will, because ply 510B is one of the two outermost plies fed into the consolidation machine (FIG. 3, ref. 200), generally remain positioned in close proximity to one side of composite 505B. The various plies 508B are bonded together to form a combined layer 514B.

In some embodiments, the melting temperatures of boundary ply 510A and of boundary ply 510B may be between 149 degrees Celsius (° C.) and 157° C., and the melting temperature of plies 508A and plies 508B may be between 158° C. and 166° C.

In some embodiments, each of plies 508A and 508B comprises a base material sheet formed from an isotactic copolymer polypropylene resin, for example resin sold under the identifier C719-35RNHP by Baskem America, Inc., of Philadelphia, Pennsylvania, and in which elongated support fibers, arranged as discussed above, are embedding. While isotactic materials are used in some embodiments for plies 508A, 508B and for boundary plies 510A, 510B, plies 508A, 508B and boundary plies 510A, 510B may comprise non-isotactic materials in other embodiments. Other copolymer materials may be used as well as the base materials in plies 508A, 508B and in boundary plies 510A, 510B. In some embodiments, including one or more in which plies 508A and 508B have base materials made from the C719-35RNHP resin, each of boundary plies 510A and 510B comprises a base material sheet formed from an isotactic copolymer polypropylene resin, for example resin sold under the identifier R7021-50RNA by Baskem America, Inc., and in which elongated support fibers, arranged as discussed above, are embedded. The C719-35RNHP polypropylene base material has a melting temperature of approximately 162° C., a melt flow of about 35 grams in ten minutes when measured at a temperature of 230° C., and an isotactic impact copolymer polymer chain classification. The R7021-50RNA polypropylene base material of the boundary plies has a melting temperature of approximately 153° C., approximately 9° C. lower than the melting temperature of the C719-35RNHP base material of the primary body plies. The R7021-50RNA base material has a melt flow of about 50 grams in ten minutes when measured at a temperature of 230° C., and the R7021-50RNA base material has an isotactic impact copolymer polymer chain classification.

In the illustrated embodiment of FIGS. 5A and 5B, composite 505A and composite 505B mirror each other, each being formed from the same number of plies. However, in other embodiments, the number of common plies 508A used to form composite 505A may be different from the number of common plies 508B used to form composite 505B. For example, composite 505A may be formed from three plies, and composite 505B may be formed from six plies.

Referring also to FIG. 5C, after composite 505A and composite 505B are formed, further lamination may be performed to bond the two composites to a core 512 via a lamination system 502, which again may be a consolidation machine as discussed with respect to FIG. 3. Lamination system 502 comprises belt rollers 504, and the system is configured to receive composite 505A, composite 505B, and a core 512 between belt rollers 504. Composite 505A and composite 505B are oriented so that the material from initial boundary ply 510A and the material from the initial boundary ply 510B are positioned adjacent to and abutting the core 512 when the three component layers are fed into the belt rollers. The materials are pulled by the belt rollers in the direction of the arrow during lamination.

Core 512 may comprise a foam material that may be fed by a rolled source of the foam material into the consolidation machine, as discussed above with respect to FIG. 3, or may be a more rigid sheet of foam material fed into the consolidation machine by hand. In one or more embodiments, however, core 512 may be a generally planar sheet of a thermoplastic polymer that is similar to or the same as the thermoplastic material that comprises the base material of boundary plies 510A, 510B. Thus, in some embodiments, core 512 may comprise a generally planar sheet of R7021-50RNA polypropylene resin available from Baskem America, Inc, having a melting temperature of 153° C. However, in other embodiments, core 512 may comprise a material different than initial boundary ply 510A and initial boundary ply 510B. Core 512 of the embodiment illustrated in FIG. 5C is provided without support fibers therein. However, in other embodiments, support fibers, e.g., support fibers, may be provided within core 512. In some embodiments, core 512 may comprise a material other than foam or a fiber-reinforced thermoplastic sheet, such as a material having a honeycomb structure, a lightweight material, or some other material. The material for core 512 may be selected to provide desired properties. For example, a material for core 512 may be selected that will provide a desired level of structural rigidity, a desired amount of strength, or to provide some other property, such as thermal insulation. The material within core 512 may be selected so that core 512 will bond with material of boundary plies 510A, 510B, and this may be accomplished by using similar polymer materials, such as polypropylenes, in each of boundary plies 510A, 510B and core 512. Core 512 may have a larger thickness than the boundary plies and the other plies.

As discussed above, lamination system 502 comprises a heating element 506C and a heating element 506D. The heating elements may be positioned in various locations with respect to the laminate, e.g. within belt rollers 504 or as belt heaters (FIG. 3, at 216), and different types of heating elements and different numbers of heating elements may be used. During lamination using lamination system 502, heating element 506C and heating element 506D are configured to generate heat so that the temperature of the polymer base materials in the laminate component plies are raised to a second heating temperature that is higher than the melting temperature of the base materials in initial boundary ply 510A and in initial boundary ply 510B but lower than the melting temperature of the base materials of the common plies in combined layer 514A and combined layer 514B. Thus, lamination system 502 is configured to melt only the material of composite 505A and the material of the composite 505B that is in contact with the generally planar major facing surfaces of core 512.

The material within common plies 508A, 508B may be selected so that plies 508A, 508B will bond with each other, with boundary plies 510A, 510B, and with core 512, and this may be accomplished by using a similar material such as polypropylene in each of the plies 508A, 508B, the boundary plies 510A, 510B, and the core 512.

Different materials may be selected for common plies 508A, 508B, boundary plies 510A, 510B, and core 512. These materials may be selected to provide structural rigidity, smoothness, strength, thermal insulation, or other desired properties. The materials selected for plies 508A, 508B, boundary plies 510A, 510B, and core 512 may also be selected from among semicrystalline thermoplastic polymers, which as should be understood have a well-defined and precise melt temperature. As discussed further below, in embodiments discussed herein, the boundary ply base material melt point is below the common ply base material melt point. Thus, in one or more embodiments, a semicrystalline thermoplastic homopolymer (e.g., a polypropylene) may be selected for the common ply base material and a semicrystalline thermoplastic copolymer (e.g., a polypropylene) may be selected for the boundary ply base material. As should be understood, homopolymer polypropylenes generally have a common melt temperature, whereas melt temperature for a copolymer polypropylene is more variable. Thus, given the melt temperature of a homopolymer polypropylene common ply base material that may be selected, a copolymer polypropylene may be selected as the boundary ply base material that has a melt temperature sufficiently below the selected common ply base material melt temperature, as discussed below. It will also be understood, however, that both the common ply base material and the boundary ply base materials may be copolymer thermoplastic polymers.

Utilization of materials, such as semicrystalline thermoplastic polymers, that melt at narrowly defined temperatures facilitates selection of base materials for the common and boundary plies because the precision of the materials' melt temperature allows use of common ply base materials and boundary ply base materials having melt temperatures that, while different, are nonetheless relatively close to each other and to the selected temperature to which the consolidation machine drives the laminate component materials. As should be understood, the consolidation machine heaters heat the laminate component materials to a temperature that is selectable as part of the machine configuration, but there is some degree of variability in this temperature. In one or more embodiments, therefore, it is desirable to select a base material for the boundary ply and a base material for the common plies that have respective melt temperatures sufficiently different from each other that it is possible to set the consolidation machine to heat the plies to a temperature that is sufficiently above the boundary ply base material melt temperature and simultaneously sufficiently below the common ply base material melt temperature that the consolidation machine heating temperature will be above the boundary ply base material melt temperature and below the common ply base material, with accommodation for variability in the consolidation machine heating temperature and tolerances in the boundary ply base material melt temperature and the common ply base material melt temperature. That is, the consolidation machine heating temperature +/− that temperature's variability does not overlap either the boundary ply base material melt temperature, +/− its tolerance or the common ply base material melt temperature, +/− its tolerance. Use of a semicrystalline thermoplastic polymer, in some embodiments, minimizes the variabilities in the melt temperatures of the boundary ply base material and the common ply base materials, thereby allowing selection of boundary ply and common ply base materials having melt temperatures closer to each other than would likely be possible with base materials having greater variability in their melt temperatures. This may result in a greater selection of boundary ply base materials and common ply base materials to meet the desired material characteristics of each material, as described above, provided that the boundary ply base material melt temperature is below the common ply base material melt temperature and that the gap between those temperatures allows for control of the consolidation machine to a laminate component heating temperature between those two temperatures at a level that does not overlap either base material melt temperature.

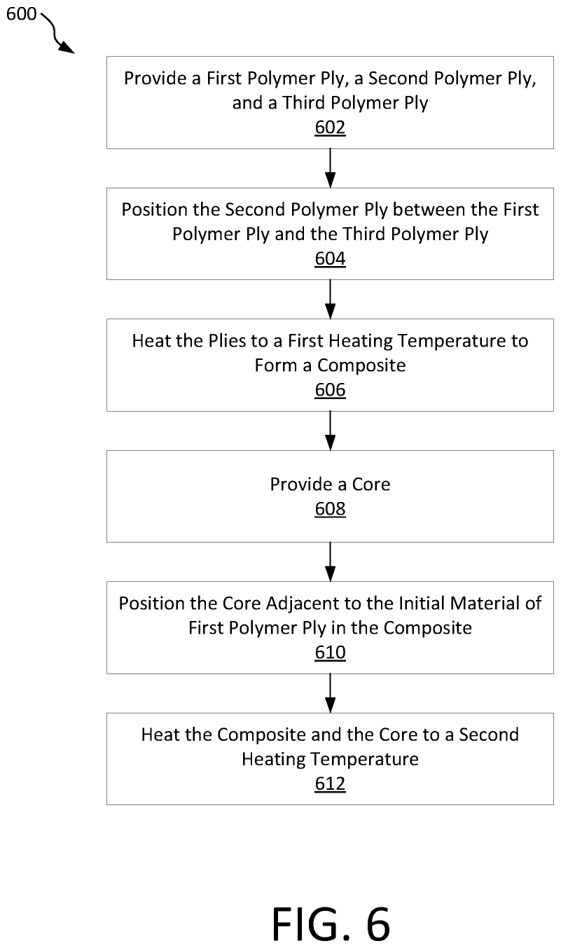

Methods for forming a composite panel are also contemplated, and a flow chart illustrating an example method 600 of forming a composite panel is illustrated in FIG. 6. At operation 602, a first polymer ply, a second polymer ply, and a third polymer ply are provided. These plies may each be provided in the form of a polymer, for example a thermoplastic or glass fiber reinforced thermoplastic sheet, and each of these plies may comprise a polypropylene material. The plies may comprise a semicrystalline polymer thermoplastic in some embodiments. In some embodiments, plies may comprise a polypropylene. In some embodiments, plies may comprise a copolymer polypropylene. In some embodiments, plies may comprise an isotactic copolymer polypropylene. The plies may comprise a polymer resin material in some embodiments.

The first polymer ply has a plurality of elongated fibers embedded therein, and the fibers are substantially parallel to a first fiber axis of the composite panel. The first polymer ply also comprises material with a first melting temperature, and this melting temperature may be between about 149° C. and about 157° C. in some embodiments. The second polymer ply has a plurality of fibers embedded therein, and the elongated fibers of the second polymer ply are substantially parallel to a second fiber axis of the composite panel. The second polymer ply is bonded to the first polymer ply so that the second fiber axis is substantially perpendicular to the first fiber axis. Furthermore, the second polymer ply comprises material with a second melting temperature that is higher than the first melting temperature. In some embodiments, this melting temperature may be between about 158° C. and about 166° C. The third polymer ply also has a plurality of elongated fibers embedded therein. The third polymer ply is bonded to the second polymer ply opposite the first polymer ply so that the plurality of fibers of the third polymer ply is substantially parallel to the first fiber axis. The third polymer ply comprises material with the second melting temperature. The second polymer ply is positioned between the first polymer ply and the third polymer ply at operation 604. The support fibers may be glass fibers.

In some embodiments, the total number of fibers in the plies extending in a direction parallel to the first fiber axis may be greater than the number of fibers in the plies extending in a direction parallel to the second fiber axis so that the rigidity of the composite panel may be greater along the first fiber axis than it is along the second fiber axis. However, in other embodiments, the total number of fibers in the plies extending in a direction parallel to the first fiber axis may be equal to the number of fibers in the plies extending in a direction parallel to the second fiber axis so that the rigidity of the composite panel along the first fiber axis may be the same as the rigidity of the composite panel along the second fiber axis.

At operation 606, the first polymer ply, the second polymer ply, and the third polymer ply are heated to a first lamination temperature to form a composite. The first lamination temperature is higher than the first melting temperature and the second melting temperature. Thus, heating to the first lamination temperature causes the first polymer ply, the second polymer ply, and the third polymer ply to melt so that the plies are bonded together to form a composite. The initial material from the first polymer ply is provided at a first side of the composite after heating to the first lamination temperature. In some embodiments, the composite formed at operation 606 may be cooled before proceeding.

At operation 608, a core is provided. This core may comprise a polypropylene material having approximately the same melting temperature as the material of the first polymer ply. At operation 610, the core is positioned adjacent to the first side of the composite so that the core is positioned adjacent to the initial material of the first polymer ply that is in the composite.

At operation 612, the composite and the core are heated to a second lamination temperature. This second lamination temperature is higher than the first melting temperature of the first polymer ply, so lamination at the second lamination temperature causes the material at the first side of the composite (which is generally the material from the first polymer ply) to melt. However, the second lamination temperature is lower than the second melting temperature of the second polymer ply and the third polymer ply, so lamination at the second lamination temperature generally will not cause the material at areas away from the first side of the composite to melt.

While one or more preferred embodiments of the invention are described above, it should be appreciated by those skilled in the art that various modifications and variations can be made in the present invention without departing from the scope and spirit thereof. For example, alternate embodiments of composite panels in accordance with the present disclosure may have fewer, or more, layers than the number of the discussed embodiments. It is intended that the present invention cover such modifications and variations as come within the scope and spirit of the appended claims and their equivalents.

### Conclusion

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A method of forming a composite panel for a vehicle, the method comprising:
providing a first polymer ply having a plurality of fibers embedded therein, the plurality of fibers being substantially parallel to a first fiber axis of the composite panel, the first polymer ply comprising material with a first melting temperature;
providing a second polymer ply having a plurality of fibers embedded therein, the plurality of fibers of the second polymer ply being substantially parallel to a second fiber axis of the composite panel, the second polymer ply comprising material with a second melting temperature that is higher than the first melting temperature;
providing a third polymer ply having a plurality of fibers embedded therein, the third polymer ply comprising material with the second melting temperature;
positioning the second polymer ply between the first polymer ply and the third polymer ply so that the second polymer ply abuts the first polymer ply and the third polymer ply, the second polymer ply being positioned relative to the first polymer ply so that the second fiber axis is substantially perpendicular to the first fiber axis, the third polymer ply being positioned relative to the second polymer ply opposite the first polymer ply so that the plurality of fibers of the third polymer ply is substantially parallel to the first fiber axis;
heating the first polymer ply, the second polymer ply, and the third polymer ply at a first temperature to cause the first polymer ply, the second polymer ply, and the third polymer ply to bond together to form a composite with material from the first polymer ply at a first side of the composite, the first temperature being higher than the second melting temperature;
providing a core;
positioning the core adjacent to the first side of the composite so that the core and the first side of the composite abut each other; and
heating the composite and the core to a second temperature that is greater than the first melting temperature but less than the second melting temperature.

2. The method of claim 1, wherein the first polymer ply, the second polymer ply, and the third polymer ply each comprise a polymer sheet.

3. The method of claim 2, wherein the first polymer ply, the second polymer ply, and the third polymer ply each comprise a polypropylene material.

4. The method of claim 3, wherein the material of the first polymer ply has a melting temperature between approximately 149 degrees Celsius and approximately 157 degrees Celsius, wherein the material of the second polymer ply and the third polymer ply has a melting temperature between approximately 158 degrees Celsius and approximately 166 degrees Celsius.

5. The method of claim 4, wherein the core comprises a polypropylene material having approximately the same melting temperature as the material of the first polymer ply.

6. The method of claim 2, wherein the first polymer ply, the second polymer ply, and the third polymer ply each comprise a polymer resin material.

7. The method of claim 6, wherein the composite panel is disposed so that the first fiber axis is substantially parallel to the floor structure.

8. The method of claim 7, wherein rigidity of the composite panel is greater along the first fiber axis than the second fiber axis.

9. The method of claim 1, wherein the composite panel does not comprise any adhesive layer.

10. The method of claim 1, wherein a glass to resin ratio of the fibers within the composite that are parallel to the first fiber axis is greater than a glass to resin ratio of the fibers within the composite that are parallel to the second fiber axis.

11. The method of claim 10, wherein respective thicknesses of the first polymer layer, the second polymer layer, and the third polymer layer in a direction perpendicular to the first fiber axis and the second fiber axis are substantially the same.

12. The method of claim 1, wherein the fibers of the first, the second, and the third polymer layers are glass fibers.

13. A composite panel, the composite panel comprising:
a first polymer ply having a plurality of fibers embedded therein, the plurality of fibers being substantially parallel to a first fiber axis of the composite panel, the first polymer ply comprising material with a first melting temperature;
a second polymer ply having a plurality of fibers embedded therein, the plurality of fibers of the second polymer ply being substantially parallel to a second fiber axis of the composite panel, the second polymer ply abutting the first polymer ply, the second polymer ply being bonded to the first polymer ply so that the second fiber axis is substantially perpendicular to the first fiber axis, the second polymer ply comprising material with a second melting temperature that is higher than the first melting temperature;
a third polymer ply having a plurality of fibers embedded therein, the third polymer ply abutting the second polymer ply, the third polymer ply being bonded to the second polymer ply opposite the first polymer ply so that the plurality of fibers of the third polymer ply is substantially parallel to the first fiber axis, the third polymer ply comprising material with the second melting temperature; and
a core,
wherein the first polymer ply, the second polymer ply, and the third polymer ply are bonded together to form a composite by heating the first polymer ply, the second polymer ply, and the third polymer ply at a first temperature that is higher than the second melting temperature, wherein initial material from the first polymer ply is provided at a first side of the composite, wherein the composite is bonded to the core by positioning the first side of the composite adjacent to the core and heating the composite and the core at a second temperature that is higher than the first melting temperature but lower than the second melting temperature.

14. The composite panel of claim 13, wherein the first polymer ply, the second polymer ply, and the third polymer ply each comprise a polymer sheet including a polypropylene material.

15. The composite panel of claim 14, wherein the material of the first polymer ply has a melting temperature between approximately 149 degrees Celsius and approximately 157 degrees Celsius, wherein the material of the second polymer ply and the third polymer ply has a melting temperature between approximately 158 degrees Celsius and approximately 166 degrees Celsius.

16. The composite panel of claim 15, wherein the core comprises a polypropylene material having approximately the same melting temperature as the material of the first polymer ply.

17. The composite panel of claim 13, wherein the composite panel does not comprise any adhesive layer.

18. The composite panel of claim 13, further comprising:
a first scrim layer bonded to an outer surface of the first polymer layer; and
a second scrim layer bonded to an outer surface of the third polymer layer.

19. The composite panel of claim 18, further comprising a fiberglass sheet bonded to one of the first and the second scrim layers.

20. A vehicle comprising:
a chassis including a wheel assembly; and
a body supported by the chassis, the body including a floor structure, a roof panel, a pair of sidewalls, a rear wall and a front wall, the front wall including a curved portion, the curved portion being formed by at least one composite wall panel, the at least one composite wall panel comprising
a first polymer ply having a plurality of fibers embedded therein, the plurality of fibers being substantially parallel to a first fiber axis of the composite wall panel, the first polymer ply comprising material with a first melting temperature;
a second polymer ply having a plurality of fibers embedded therein, the plurality of fibers of the second polymer ply being substantially parallel to a second fiber axis of the composite wall panel, the second polymer ply being bonded to the first polymer ply so that the second fiber axis is substantially perpendicular to the first fiber axis, the second polymer ply comprising material with a second melting temperature that is higher than the first melting temperature;
a third polymer ply having a plurality of fibers embedded therein, the third polymer ply being bonded to the second polymer ply opposite the first polymer ply so that the plurality of fibers of the third polymer ply is substantially parallel to the first fiber axis, the third polymer ply comprising material with the second melting temperature; and
a core,
wherein the first polymer ply, the second polymer ply, and the third polymer ply are bonded together to form a composite by heating the first polymer ply, the second polymer ply, and the third polymer ply at a first heating temperature that is higher than the second melting temperature, wherein initial material from the first polymer ply is provided at a first side of the composite, wherein the composite is bonded to the core by positioning the first side of the composite adjacent to the core and heating the composite and the core at a second heating temperature that is higher than the first melting temperature but lower than the second melting temperature.
